(19) United States
(12) Patent Application Publication
(10) Pub. No.: US 2024/0281863 A1
(43) Pub. Date: Aug. 22, 2024

(54) Online Shopping Platform

(71) Applicants: Karim Khashoogi, La Jolla, CA (US); Nabila Khashoggi, La Jolla, CA (US); Sean Daly, La Jolla, CA (US)

(72) Inventors: Karim Khashoogi, La Jolla, CA (US); Nabila Khashoggi, La Jolla, CA (US); Sean Daly, La Jolla, CA (US)

(21) Appl. No.: 18/111,060

(22) Filed: Feb. 17, 2023

(51) Int. Cl. G06Q 30/0601; G06Q 30/0282; G06Q 50/00

(52) U.S. Cl. CPC G06Q 30/0631; G06Q 30/0282; G06Q 50/01

(57) ABSTRACT

This application will support the ability to form a group of friends or family that allows each of the members of the group the ability to input opinions regarding goods or services to the other members of the group. This will allow members of the group that is selected by the members of the group the opportunity to provide feedback to other members in the group.

### FIELD OF THE INVENTION

In today's world consumers look for reviews of products or services online. Oftentimes the reviews that are available are not known to the person who is performing the search. If the reviews are favorable, the person can make an informed decision whether he or she wishes to buy that product or seek that service. However, if the review is inaccurate, the consumer may be left with the idea that product or service is good when in fact it is less than desirable.

Many people, however, in addition to looking for online reviews from unknown parties, will also ask neighbors and family for recommendations about products and services. A positive recommendation from a friend or neighbor is usually a trusted recommendation. Often the person will place more weight on the recommendation from a friend or family member when basing such a decision.

Today, in the digital world, groups can be formed for a multitude of purposes such as group chats, group texts, or similar situations. This same type of group can also be a very effective forum for a product or service review. This application enables the individual to review a product and then share that product information with a group and communicate to others within the group. The group can be as large or as small as the user desires and can be comprised of family members, friends, or neighbors.

In this application, a user can create an avatar to represent them so that the members of the group immediately know the source of the review. The creation of an avatar for the individuals in the group enables those who are members of the group to immediately recognize the source of the review and immediately lend credence to the review. The length of the review that may be posted can be unlimited.

### PRIOR ART

There are many other prior art applications related to online applications and online shopping applications.

A representative sample of this application can be found at Siddique U.S. Pat. No. 10,002,337. The Siddique application is a method for collaborative shopping in a community environment and it specifically based on an online apparel modeling system that allows the users to have three-dimensional models of their physical profile created and the user may then purchase various goods and/or services and collaborate with the other users in the online environment. This patent incorporates the concept of creating group sharing in the online shopping experience but adds several unique features to the application.

Another representative example in the prior art can be found at Abraham, U.S. Patent Publication 2006/0122895. Abraham references a method of collaborating between web based shopping carts. Access can be established between the shopping cart and at least one other shopping cart with the shopping carts being associated with the shoppers who are different from the shopper. A link can then be established between the web-based shopping and at least one other shopping cart. Through the link, the shopper can be permitted to access items in the other person's shopping cart. Again, this demonstrates another application which has collaboration between persons in a group.

A representative example of an application which uses internet content as a main link between social networks by linking the internet users who have similar interests can be found at Robinson, U.S. Pat. No. 8,117,281. This application has the ability to link individuals with similar taste or preferences. The present application does not necessarily strive to link persons with similar tastes but friends tend to have similar tastes just by the nature of the friendship relationship.

The Fujioka patent, U.S. Pat. No. 9,744,466 references an upsell engine that links particular products and also has associated products so the user can purchase the first item and then purchase a second item that it related to the first item. This application uses algorithms which are not novel to discern the particular taste of the consumer based on past purchases.

The Calabria, U.S. Pat. No. 7,761,342 reference uses a social network to enable a review system. This includes a review engine that is connected to support modules and databases that retrieves reviews based on the subject end user relationships to the authors of the review. The engine allows reviews to be sorted and filtered in order in terms of relevance when presented to the user. This allows reviews to be left based on prior references incorporate or teach the features of the current application.

The undersigned would concede that the concept of group sharing information is not novel but this application adds features such as artificial intelligence to that concept that make the application novel.

### BRIEF DESCRIPTION OF THE INVENTION

This is an online application which allows a group of people such as family or friends to form a group for the purpose of reviewing products and services online and sharing those reviews with members of the group. The group can be as large or as small as the individual desires. Members of the group can form subsets of groups to selectively limit the flow of information to individuals in a particular subset of a group.

In addition to the ability to share and review, the user also has the ability to purchase items by providing links to the parent vendors or suppliers. Members of the group, as they are established, also set up individual preferences with other members of the group. If a person in the group becomes aware of a product or service that may be useful to another member of the group that person can share that information with the individual or to the group of individuals within the group.

Additionally, an avatar would be used to visually demonstrate the identity of the reviewer or user. Reviews on products and services could also be stored and reviewed for future use or past use.

This particular application may be accessible through a variety of portable electronic devices including but not limited to phones, tablets, lap top computers and desktop computers.

### BRIEF DESCRIPTION OF THE DRAWINGS

There are no drawings necessary other than for illustrative purposes.

### DETAILED DESCRIPTION OF THE EMBODIMENTS

The platform blends social media with shopping and the ability to review products and services within a defined group of individuals. It is designed to enable multiple parties to connect and share information on a real time basis.

Through its mobile apps and desktop web interface, users can create an account, and add friends to help make buying fun and purposeful. Online marketplaces are cluttered with products, often with fake reviews, that makes shopping hard and frustrating and less than predictable.

The platform facilitates the sharing of product ratings and reviews between friends, which creates trust in product reviews as opposed to the anonymous ratings and reviews found commonly on the large online marketplaces. The user will be able to access the platform using a portable electronic device or a laptop and establish an account; the individual account may be password protected. The user can also insert security measures such as security questions into the account to protect the user from security threats.

### Examples of Use:

A new user would download the application from a provider of applications. The user would create an account, and then pick categories of interest in shopping: Home, Auto, Electronics, etc. They would be able to add friends to their circle of trust, by email address or telephone number. Every new user may further segregate the interests of persons who share similar interests and, in that way, compartmentalize their group of friends or family into separate subgroups.

The user is then presented with a search bar. They could type in anything they are interested in buying, for example a TV. The App would present them a list of TV's that friends have highly rated and through a link button would take them to the various online marketplaces to purchase the item. The platform that is used with this application uses the affiliate-link system to generate revenue.

The search is enhanced by machine learning artificial intelligence algorithms that closely match what the users are looking for with similar items that friends they are linked to have also purchased. The link scope can be adjusted to expand the circle of friends, to friends of friends creating a tree of trusted friends.

The scope of each group can also include famous or notable people with accounts such as celebrities. Celebrities are typically not experts about products or services but are paid spokespersons about a product or service. A disclaimer about the celebrity endorsement will be included on the application. Because many celebrities are not experts about product or service, a rating system is not provided for the celebrity endorsement.

The scope can also be expanded to domain experts or experts on products or services for their input. These “experts” may not be considered friends but are included within the group to add expert advice on products or services. Each of the members of the group can also review the expert and review the product or service. The ability to review the expert adds credibility to share with other members of the group. Each of the users within the group can also review the opinions of the experts.

The screenshot for the application graphically presents the users in a group as avatars that are created by each individual user. Each of the users can recommend a product or service by using a rating system such as “gold” stars from 1-5 to rate the item in desirability. It is anticipated that a rating of “1” indicates a product or service that is undesirable while a rating of “5” indicates a highly desirable product or service.

Similarly, the users in the group can also rate the experts that have been included using a similar scale.

The end result of the platform is to remove the frustration of online shopping, and make it fun by creating trust in product reviews and recommendations which reduces time-to-find and lowers transaction costs by lowering return rate.

The design of the platform involves an application that resides on servers that are hosted on large cloud Internet providers to allow for scale, and quick access throughout the World. For example—Amazon's AWS and/or Google Cloud Computing Engine. This software is run under a client-server model where the server software “in the cloud” talks to the various clients, which would be mobile applications on iPhone's and Android phone's and other mobile devices like tablets, as well as web clients from web browsers on desktop computers etc. This server software is comprised of software that has database machine earning, client application access protocols, and gateway software to interact with the large online shopping marketplaces. The system will provide links to stores where an individual user can purchase products or services directly from the seller.

The inventor claims:

1. A mobile online review and shopping application, which is comprised of:
a. software;
wherein the software supports a platform;
wherein the platform is online;
b. a plurality of users;
wherein a user establishes an account;
wherein the plurality of users are formed into groups;
wherein the plurality of users leave reviews;
wherein the plurality of users are represented by individual avatars;
c. artificial intelligence algorithms;
wherein artificial intelligence algorithms are used for each individual user in the group;
wherein the artificial intelligence algorithms establish preferences for individual users;
d. portable electronic device;
wherein the user accesses the platform using a portable electronic device;
e. a plurality of avatars;
wherein each of the members of the group is represented by an avatar;
wherein the individual members of the group select an avatar;
f. links to sellers;
wherein links to sellers are provided;
wherein the links are hyperlinks;
wherein the individual can purchase a product or service through the link;
g. links for celebrity endorsements;
h. links to experts;
wherein the experts are limited to a particular product or service.

2. A mobile online review and shopping application as described in claim 1 wherein a rating system for reviews is established.

3. A mobile online review and shopping application as described in claim 1 wherein a rating system for the experts is provided.

4. A mobile online review and shopping application as described in claim 1 wherein the plurality of users can further separate groups by preferences.

5. A mobile online review and shopping application as described in claim 1 wherein the experts are limited to specific products or services.

6. A mobile online review and shopping application as described in claim 1 wherein the link for celebrity endorsements is included with a disclaimer.

7. A mobile online review and shopping application as described in claim 1

8. A mobile online review and shopping application as described in claim 1

9. A mobile online review and shopping application as described in claim 1

10. A mobile online review and shopping application as described in claim 1.
